(19) United States
(12) Patent Application Publication
(10) Pub. No.: US 2016/0243597 A1
(43) Pub. Date: Aug. 25, 2016

(54) MAGNETIC MOUNT FOR BLASTING EQUIPMENT AND RELATED METHODS

(71) Applicant: PSI Pressure Systems Corp., Baytown, TX (US)

(72) Inventor: Todd A. Shawver, Battle Creek, MI (US)

(21) Appl. No.: 15/045,845

(22) Filed: Feb. 17, 2016

Related U.S. Application Data
(60) Provisional application No. 62/120,087, filed on Feb. 24, 2015.

(51) Int. Cl. B08B 9/032; B08B 9/043; F28G 15/00; F28G 9/00; F28G 15/02; F28G 15/04; B08B 3/02; B08B 9/08

(52) U.S. Cl. CPC B08B 9/0325; B08B 3/024; B08B 9/0433; B08B 9/0813; F28G 9/00; F28G 15/02; F28G 15/04; F28G 15/003

(57) ABSTRACT

A water blasting apparatus and related method are adapted to clean equipment. The apparatus includes a track having telescoping rails, a connector moveable along the track, and a water blasting device adapted to shoot water at a pressure above 1000 psi, joined with the connector. One or more rare earth magnets join the track with a ferromagnetic structure, thereby holding it in a fixed orientation relative to the equipment to be cleaned. The apparatus can include a proximity sensor to ensure the track is adequately anchored, and an auto shut-off system when it is not. The method can include connecting the water blasting device to the track, magnetically coupling the track to a structure so that the nozzle is proximal equipment, and so that the elongated track is maintained in a fixed orientation, and shooting water at high pressure toward the equipment, while safely restraining the water blasting device.

### BACKGROUND OF THE INVENTION

The present invention relates to water blasting equipment and more particularly to high pressure water blasting devices adapted to clean equipment such as heat exchangers, falling pressure evaporators, storage tanks, tubes, piping, towers and similar equipment.

There are a variety of industrial piping systems using in conjunction with different industries, such as, chemical processing, recycling, polymer forming, oil and gas refining and other industries. These industrial piping systems frequently require cleaning, resurfacing, painting and/or coating. As an example, in the oil refining industry, special equipment such as heat exchangers and evaporators are utilized. Over time, the bores and exterior walls of the heat exchanger's tubes can corrode, scale or exhibit excessive residue and buildup. This buildup and/or residue can decrease the efficiency of heat transfer through the heat exchanger. In turn, operating costs for the heat exchanger can significantly increase.

Thus, the cleaning of such equipment has spawned an industry. Some manufacturers make special water blasting equipment that operates at high pressures, greater than 10,000 psi in some cases, to create a jet stream that effectively blasts or removes the scale, residue, corrosion, etc. from equipment. In connection with equipment such as heat exchangers, a small diameter lance is typically inserted into the heat exchanger tubes. High pressure water is pumped through the lance to clean the interior of the tube as it travels through the tube. In other applications, a hand-held portable cleaning lance can be held by a user who sprays equipment. The lance can include a nozzle. The user carefully inserts the nozzle and a portion of the lance into piping of the equipment to blast the unwanted material out from the piping interior. In other applications, the equipment can include a pipeline. To clean the pipeline, a user can cut into the pipeline, or remove a dedicated access panel, and then insert a lance into the pipeline to clean it under high pressure.

In all of the above equipment cleaning applications, there are inherent dangers. For example, the lances typically are difficult to prevent from buckling and/or bending while being guided into a tube. In cases where the lance is more rigid and adapted to insert into the opening of the pipe, the jet reaction from a high pressure stream shooting from the nozzle can create major safety issues. Because the water is forced through the nozzle at significant pressures, the jet from the nozzle can frequently blow backward, striking the operator. In other cases, if an operator becomes fatigued and accidentally drops the water blasting lance, it sometimes can violently thrash around under the propulsion of the jet stream. In yet other cases, the pipe to be cleaned is elevated overhead. Some operators will take shortcuts, and insert the lance into the elevated piping. This can increase the likelihood that the device will become loose and violently thrash around. In all of the above cases, there is an issue with the water blasting lances being manually handled by the users. There can be a high propensity for accidents to occur when those devices unintentionally depart from the user's hands.

Some manufacturers have attempted to address the dangers inherent with some water blasting lances, at least in connection with the cleaning of heat exchangers. For example, there are automated remote control lances, which are mechanically inserted into a heat exchanger. These assemblies, however, require the labor intensive bolting of a complex frame around the heat exchanger to properly index the lance relative to the tubes of the heat exchanger to be cleaned. The extra effort to bolt on the frame can be particularly cumbersome and time consuming. In other cases, an operator frequently has to assemble or modify a fixture or framework to adequately hold the lance so that it can be inserted into the appropriate tubes of the heat exchanger.

While there are devices to secure cleaning lances to equipment such as heat exchangers or other structures, and these devices can enhance the safety afforded to the operator, there remains room for improvement with regard to securing a water blasting device in a generally fixed location relative to the equipment and/or structure.

### SUMMARY OF THE INVENTION

A water blasting apparatus and related method are provided to enhance the safety of an operator engaged in cleaning certain equipment and structures. In one embodiment, the apparatus can include a track, a connector moveable along the track, and a water blasting device adapted to shoot water at a pressure above 1000 psi, joined with the connector. One or more high strength magnets join the track with a ferromagnetic structure, such as the equipment or structure itself or facility framework near the equipment, thereby holding the track in a fixed orientation relative to the equipment or structure to be cleaned.

In another embodiment, the track can include first and second rails that telescope relative to one another so that the length of the track can be modified to fit in a desired location. Optionally, the track can include a first section and a second section, with an intermediate or middle portion therebetween. The first rail can be the first and/or second sections, and the second rail can be the intermediate portion.

In still another embodiment, the apparatus can include a sensor, optionally a proximity sensor, to ensure the track is adequately anchored to the ferromagnetic structure, and an automatic shut-off system when it is not adequately anchored to the ferromagnetic structure.

In yet another embodiment, the magnets can be ceramic or rare earth magnets, optionally having residual inductions ranging from 2,000 Gauss to 40,000 Gauss, further optionally about 10,000 Gauss to about 20,000 Gauss.

In even another embodiment, the magnets can be outfitted with an actuator configured to selectively configure the magnet in either a magnetic mode, in which the magnet magnetically attracts to a ferromagnetic structure, or a disengaging mode, in which the magnet is able to be disengaged from the ferromagnetic structure.

In a further embodiment, first and second magnets can be pivotally joined with each opposing end of the track. Each magnet can be attached to separate and spaced apart ferromagnetic structures adjacent or on the equipment to be cleaned. The magnets can effectively secure the ends to two locations, thereby positioning the track, and thus the water blasting equipment in a fixed orientation relative to the equipment or structure.

In still a further embodiment, the connector can be in the form of a tractor that is controlled by a control unit. The tractor can include a gear or sprocket that engages the track to propel the connector, and thus the connected water blasting equipment along the track to various desired locations. Optionally, the track can include teeth or slots that cooperate with and engage the sprocket to facilitate the movement.

In yet a further embodiment, the tractor can include an actuator adapted to engage a holder or bracket contacting the water blasting device. The actuator can effectively move the holder, thereby reorienting the nozzle in varying directions to clean or blast a particular area. Due to the restraint of the device by the connector and track, its movement can be limited to a particular area of cleaning until the control unit moves the tractor again with the water blasting device.

In even a further embodiment, the method can include connecting the water blasting device to the track, magnetically coupling the track to a ferromagnetic structure so that the nozzle is proximal the equipment to be cleaned, and so that the elongated track is maintained in a fixed orientation, and shooting water at high pressure toward the equipment, while safely restraining the water blasting device.

In another, further embodiment, the method can include providing the track with a first rare earth magnet and a second rare earth magnet in different locations along the track. Each magnet can include an actuator configured to configure the respective magnet into a magnetic mode or a disengaged mode. The method can include placing the first rare earth magnet adjacent the ferromagnetic structure and moving the actuator to configure the first rare earth magnet into the magnetic mode whereby the magnet magnetically couples to the ferromagnetic structure.

In still another, further embodiment, the method can include moving the water blasting device linearly along the track from a first location to a second location along an x-axis, and/or moving or tilting the water blasting device linearly from a first location to a second location along a y-axis.

In even another further embodiment, the method can include automatically ceasing the shooting of water from the nozzle upon decoupling of the track from the at least one ferromagnetic structure. This decoupling can be detected by a sensor, such as a proximity sensor or other sensor. The sensor can send a signal to a control unit that the decoupling has occurred, and the control unit can trip a dump valve so that high pressure water is no longer conveyed to the water blasting device.

With the current embodiments of the water blasting apparatus and method, improved levels of safety for operators can be realized. Where the track and connector constrain a water blasting device for movement within a limited area to clean equipment, the water blasting device can be less likely to become loose and violently thrash around, thereby presenting a danger to the operator. With the water blasting device attached to the track and oriented in a specific manner, an operator can consistently and methodically clean a surface of certain equipment. This can result in faster cleaning times, as well as reduced power consumption and man hours. Where the track includes first and second magnetics attached to ends of the track, the track can be highly modifiable to fit a variety of configurations and spaces near equipment to be cleaned. For example, the track can be extended in length to accommodate structures, to which the magnets are attached, that are spaced apart from one another. The track also can be oriented vertically, horizontally or in various other planes, all depending on the location of the magnets coupling the device to structures surrounding the equipment. Further, given the variable length of the track, the apparatus can be quickly and efficiently positioned in confined spaces or large spaces. Where the apparatus includes a sensor, such as a proximity sensor, this can enhance safety for the operator, generally ensuring automatic shutdown of the system upon any decoupling of the track/magnets from a ferromagnetic support structure.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a water blasting apparatus of a current embodiment mounted to a track that is magnetically coupled to ferromagnetic structures in conjunction with the cleaning of a heat exchanger;

FIG. 2 is a perspective view of the track and a connector of the apparatus constraining a water blasting device;

FIG. 2A is a cross section taken along Lines 2A-2A in FIG. 2 of a first section of the track;

FIG. 2B is a perspective view of track first and second sections telescopingly connected to a middle portion;

FIG. 3 is an internal view of a gear within the connector that is able to tractor the water blasting device linearly along the track along an X axis;

FIG. 4 is a perspective view of a holder and a portion of the connector adapted to tilt or otherwise move the water blasting device along a Y axis;

FIG. 5 is a side view of the connector of FIG. 4;

FIG. 6 is a close-up perspective view of a magnet of the current embodiment;

FIG. 7 is a perspective view of the water blasting apparatus used in an adaptive environment on different structures;

FIG. 8 is a perspective view of a first alternative embodiment of the water blasting apparatus;

FIG. 9 is a perspective view of the water blasting apparatus utilized in a tank cleaning operation; and

FIG. 10 is a second alternative embodiment of the water blasting apparatus including a simplified magnetic mount and connector.

### DESCRIPTION OF THE CURRENT EMBODIMENTS

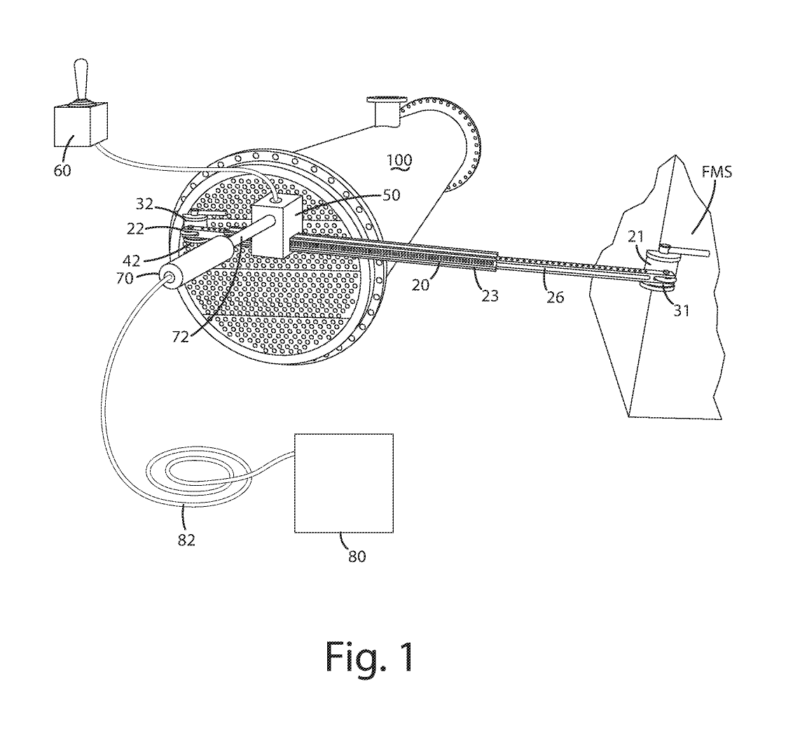

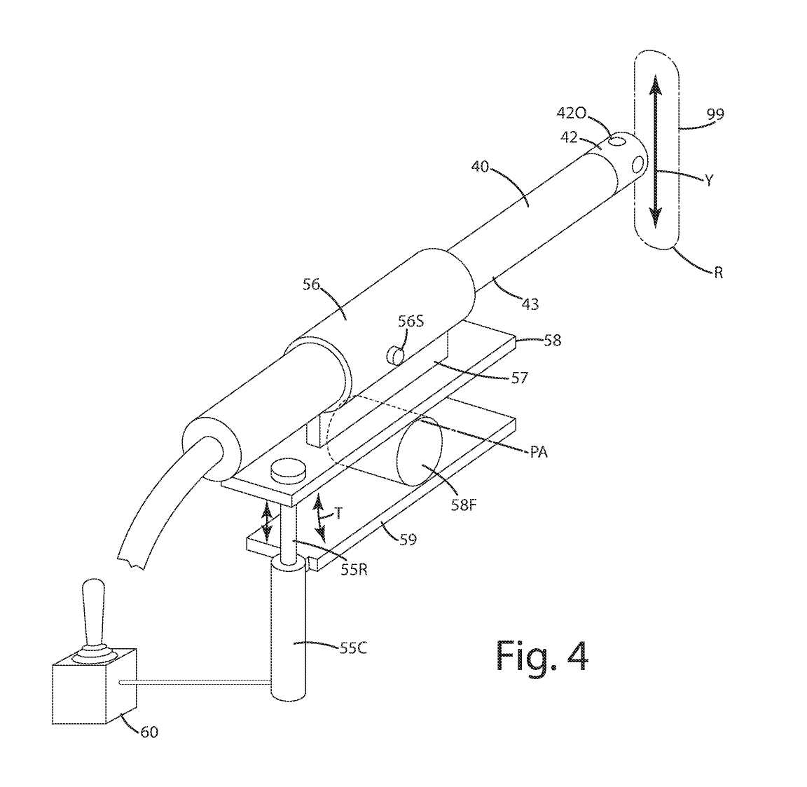

A water blasting apparatus and related method in accordance with the current embodiment is illustrated in FIGS. 1-6 and generally designated 10. The water blasting apparatus can be used to clean a heat exchanger as shown in connection with the current embodiment. Of course, the apparatus can be modified to be used in conjunction with cleaning other equipment, such as piping as shown in the first alternative embodiment and/or a tank as shown in the second alternative embodiment below. Further alternatively, the apparatus herein can be used to high pressure water blast other equipment or structures such as falling pressure evaporators, towers, piping, containers, bins, molds, impellers, mining equipment, watercraft, and a variety of other equipment or structures. Thus, it should be understood that the current embodiments are not limited to equipment associated with cleaning heat evaporators, although that is what is primarily illustrated in the current embodiment.

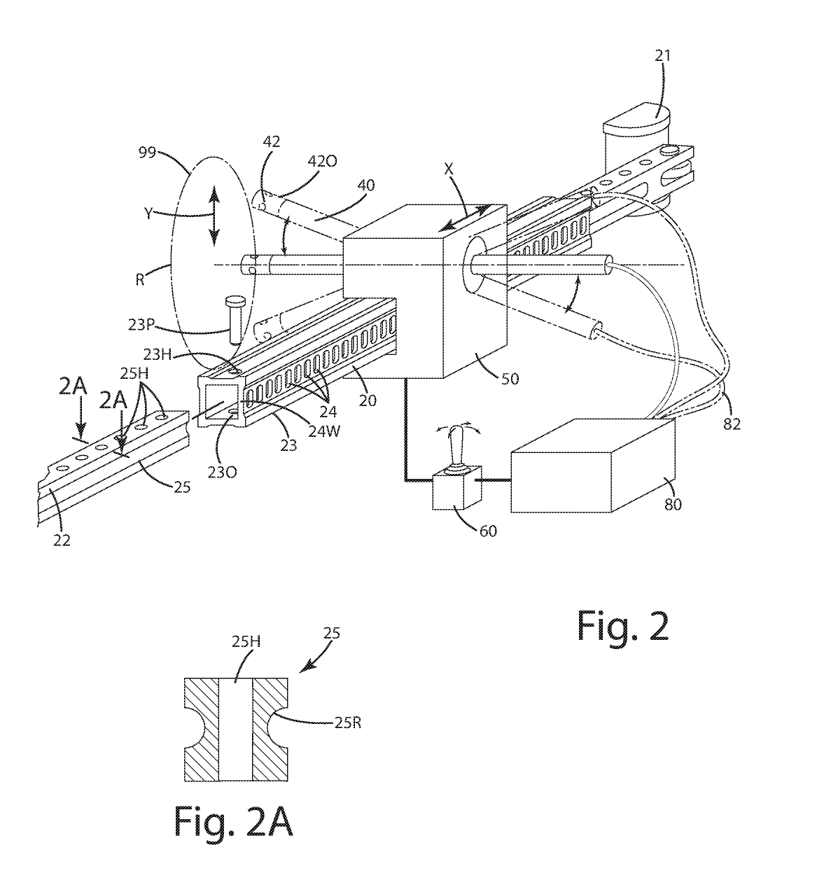

Generally, as illustrated in FIGS. 1 and 2, the water blasting apparatus can include a track 20 having first and second ends 21 and 22. At these ends, first and second magnets 31, 32 can be pivotally joined with the ends of the track. These magnets can be permanent magnets as described in further detail below, adapted to join the ends of the track 20 with the respective ferromagnetic structures. As shown in FIG. 1, the ferromagnetic structures can be a metal faceplate of the heat exchanger itself, a flange of the heat exchanger or other metal components of the heat exchanger. Alternatively, the ferromagnetic structures to which the magnets magnetically couple could be nearby or adjoining structures, such as a metal container illustrated in FIG. 1. Further, where the piping or structure to be cleaned in located within a facility, the facility is usually constructed from metal I-beams or other metal structures. The magnets can readily join with such beams or other structures. In some cases, where there are no adjacent or nearby metal structures, a metal plate can be joined with a non-metal structure, such as a wood post or beam, to provide the desired magnetic attraction and magnetic coupling of the track to the structure.

As further shown in FIGS. 1 and 2, the apparatus 10 also generally includes a water blasting device 40, illustrated as a lance or gun. The device 40 can include a barrel 42 which is associated with a connector 50 that is operably connected to the track 20. The connector 50 can be joined with a controller 60 via a hard wired electrical connection, or where appropriate, via a wireless connection, so that components of the connector and device as described further below can be operated via the control unit 60. A water source 80 can be coupled to the device 40 or otherwise in fluid communication with the same. This may be accomplished via the tubing 82 which extends from the water source 80 to the device 40. Optionally, where the device is a lance configured to extend tubing through heat exchanger tubes, the apparatus can include a drive unit 70 which can house a drive mechanism to extend and retract the hose 82 through a portion of the lance 72 and into the respective tubes of the heat exchanger. Examples of different types of drive mechanisms are illustrated in U.S. Pat. No. 3,269,659 to Shelton, as well as U.S. Pat. No. 8,192,559 to Garman, both of which are incorporated by reference in their entirety.

The specific construction, components and operation of one embodiment of water blasting apparatus 10 will now be described in further detail. As mentioned above, the water blasting apparatus 10 can include a track 20, magnets 31 and 32, a connector 50 and a water blasting device 40. The water blasting device can be a lance or gun, and can be interchangeable with any type of mechanism including a nozzle defining at least one orifice, where the blasting device is joined with a water source 80 configured to deliver water to the nozzle at a pressure optionally above 1,000 psi, further optionally above 5,000 psi, even further optionally above 5,000 psi, yet further optionally above 10,000 psi, still further optionally above 20,000 psi, more optionally above 40,000 psi, and even further optionally up to 100,000 psi.

The track 20 includes a first end 21 and a second end 22. The track 20 can be comprised of one or more rails that are telescopingly joined with one another. For example as shown in FIGS. 2A and 2B, the track 20 can include a middle or intermediate portion 23. This middle portion 23 can be in the form of a box having multiple drive slots or apertures 24 defined in a face of the intermediate portion 23, generally disposed opposite the equipment to be cleaned. The middle portion can include open ends 23O sized to receive a first section 25 and a second section 26 therewithin. In this manner, the first section and/or second section 25 and 26 can be telescopingly plugged into (or over) and joined with the middle portion. As described in other embodiments herein, one of the sections can be eliminated depending on the application.

The first and second sections 25 and 26 can be configured in the form of tubes or rails that extend outwardly away from the middle portion 23. The first and second sections can be joined with the middle portion by positioning the sections within the opening 23O a preselected distance. The middle portion and sections can be locked to one another utilizing a pin 23P that extends through a pin hole 23H defined by the middle portion 23. The pin 23P can also extend through one or more holes 25H of the respective sections, for example, the first section 25. The pin 23P can include a head and a nut to secure the spatial relationship between the middle portion 23 and the sections 25 and 26. Generally, the pin 23P and pin hole 23H can be oriented on a side of the intermediate portion 23 upon which the slots 24 are not defined. Put another way, the pin 23P and its hole 23H can be disposed parallel to the wall 24W within which the slots 24 are defined.

Optionally, the first and second sections 25 and 26 can be configured to include a longitudinal recess or slot 25R as illustrated in FIG. 2A. This longitudinal slot 25R can be disposed on opposite sides of the hole 25H, depending on the particular application. The slots 25R can be sized so that a gear 52 of the connector 50 can rotate with its teeth 52T at least partially extending into the slot or recess 25R, without the rotation of the gear being impaired by parts of the respective sections. Again, this construction can be utilized where the slots 24 extend into the interior of the middle portion 23, and the teeth 52T of the gear are sufficiently long enough to project into that opening as well. This can enable rotation of the gear, even when the respective sections are placed adjacent the slots 24 across which the gear tractors the connector 50.

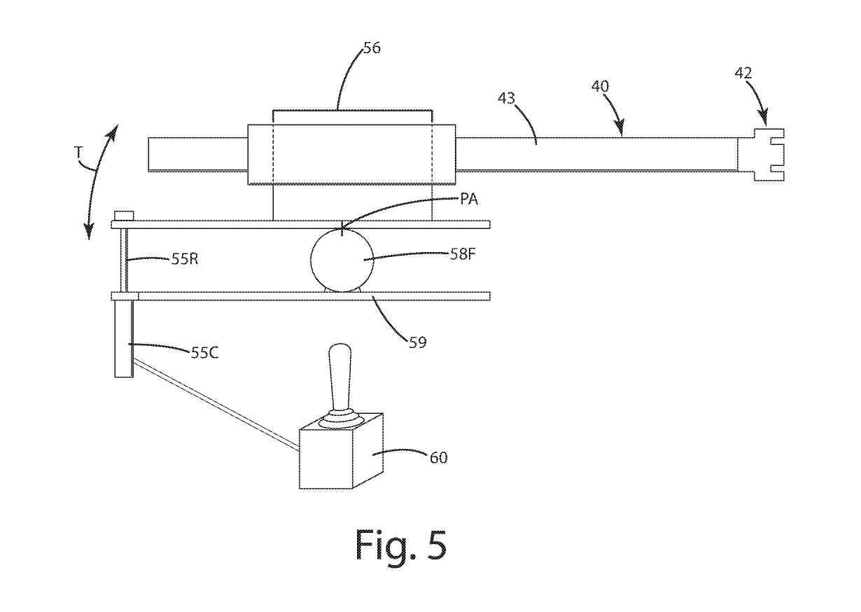

As shown in FIGS. 1, 2B and 6, the sections 25 and 26 of the track 20 can include one or more end slots or recesses 25R2, 26R2. The recesses can be configured to receive a connecting element 31C of a magnet 31 as shown in FIG. 6, or a connecting element 32C of the magnet 32, as shown in FIG. 2B. The connecting element 31C, which is similar to the connecting element 32C, of the magnet can be interposed or disposed within the respective recess. For example, connecting element 32C can be placed within the recess 25R2. When satisfactorily placed there within, a magnet connecting pin 33 is disposed through a hole or aperture defined by one side of the recess 25R2 through the open or center of the connecting element 32C and subsequently into the second or opposing side of the U-shaped recess 25R2. A nut 33N can be secured or fastened to the magnet connecting pin 33. Alternatively, a portion of the wall on a side of the recess 25R2 can be threaded to receive threads of connecting pin 33.

As shown in FIG. 6 with this type of connection to the magnets 31, 32, the track 20 and/or the respective sections 25 and 26 can be rotated an angle α relative to those magnets 31, 32. As illustrated, that angle α can be about 0 degrees to about 300+ degrees. With this variability of the mounting angle α, and the variable spatial relationship of the track relative to the magnet and the connecting element 31C, the track can be disposed in multiple orientations relative to a piece of equipment to be cleaned. This, in turn, can provide an operator with significant variability when positioning the track relative to the equipment at multiple different angles. As a result, the operator can almost always safely secure and set up the apparatus. Optionally, although shown with generally U-shaped magnet connecting elements, the magnets can be outfitted with ball and socket connectors that attach directly to the track as explained in embodiment below. Other ways of connecting the ends of the track to the magnets to provide a desired degree of mobility and articulation are also contemplated.

The track itself can be constructed from metal, polymers and/or composite materials sufficiently rigid to support the connector and water blasting equipment and hold the same in proximity to the equipment being cleaned.

The track again is configured so that when set up, its ends 21 and 22 are magnetically coupled to ferromagnetic structures FMS adjacent or included in the equipment to be cleaned. Referring to FIG. 1, the track 20 can be joined with a connector 50 that itself connects the water blasting device 40 to the track in a fixed, but modifiable or alterable configuration. The connector 50 can enable the water blasting device to be moved in preselected increments and then fixed relative to the equipment to be cleaned, for example, the heat exchanger 100 shown in FIG. 1.

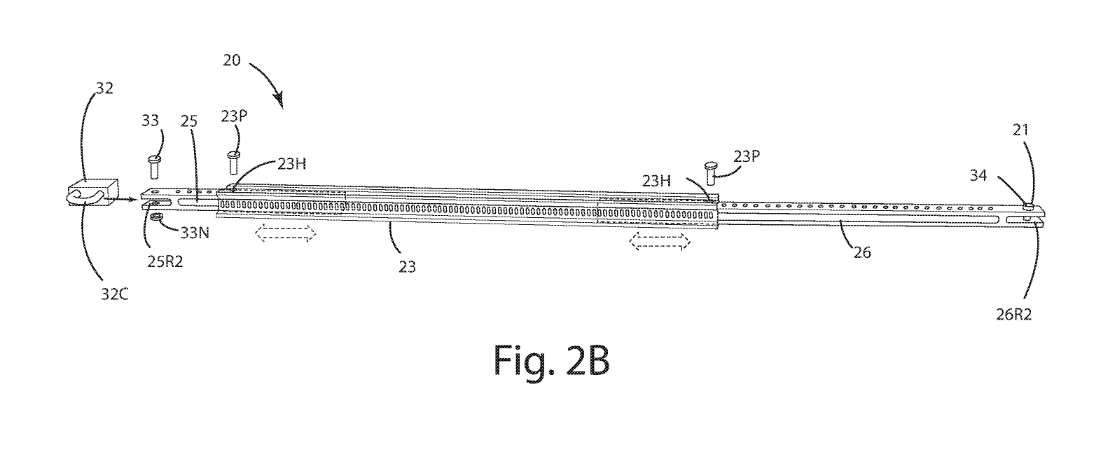

With reference to FIG. 3, the connector 50 can include a housing 54 within which other components adapted to move the connector and/or water blasting device are housed. For example, in the housing, a pneumatic, hydraulic or electric motor 55 can be housed. This motor can be joined with the gear or sprocket 52 to provide rotational force to the same, thereby tractoring the connector 50 along the track 20. For example, the motor 55 can turn the gear 52 thereby engaging the teeth 52T with the slots 42 to move the connector 50 along an X axis that is generally parallel to the length of the track 20 as shown in FIG. 2. The motor 55 can be in communication with the control unit 60 so that a user can manipulate a manual control, for example a joystick 62, to linearly move the connector 50 along the track 20, thereby moving the water blasting device 40 and its associated nozzle 42 relative to a surface or surfaces of equipment to be cleaned.

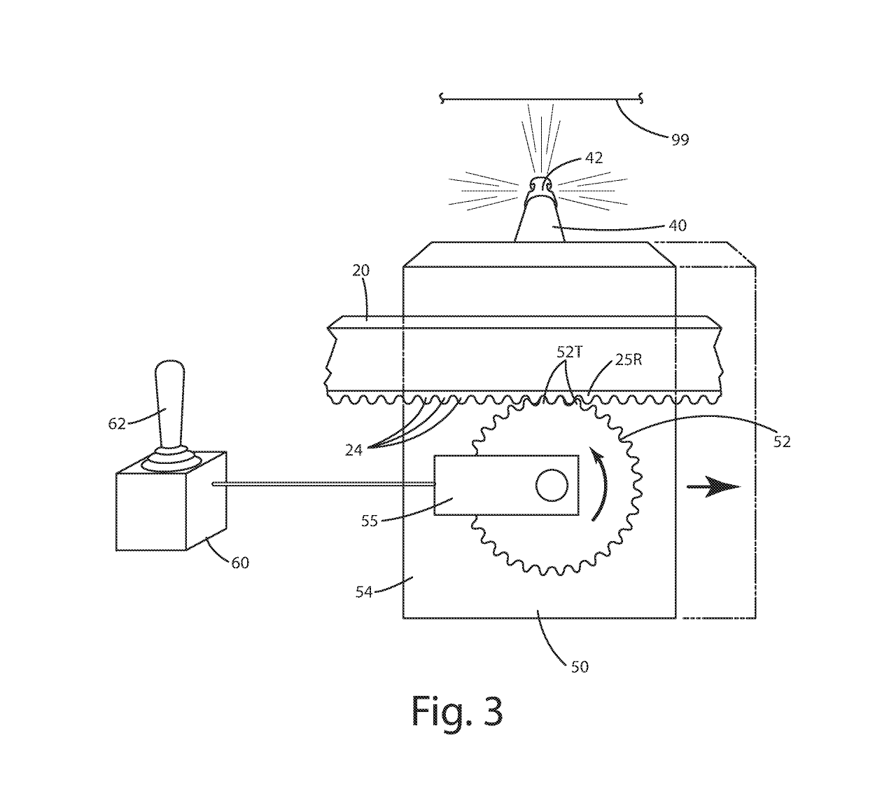

The connector 50 also can include and/or house various other components for moving the water blasting device, and in particular the nozzle 42, along a Y axis as shown in FIGS. 2 and 4. This movement along the Y axis can be accomplished in several ways. For example, the connector 50, sometimes referred to herein as the tractor, can constrain the water blasting device 40 within a holder 56. The holder 56 can be in the form of a tube through which the barrel 43 of the device fits. The holder can include a set screw 56S or other clamp or cam structure that can hold the barrel 43 in a fixed position relative to the holder 56. The holder 56 can be joined via a bracket 57 to a tipping plate 58. The tipping plate 58 can be mounted on a fulcrum element 58F and can pivot about a pivot axis PA that moves dynamically across the outer surface of the fulcrum 58F. The bottom of the fulcrum 58F can be welded or fixed to a support plate 59 so that the fulcrum 58F does not move relative to that support plate 59.

The tipping plate 58 moves relative to the fulcrum 58F, and again can pivot about the pivot axis PA in the tilt or tipping direction T shown with arrows in FIG. 4. When joined with the tipping plate and tipping in the direction T, the holder and thus the barrel of the device, generally tilts or moves through a variety of angles about the pivot axis PA, thereby moving the nozzle 52 along a Y axis, across a preselected area or region R of the equipment to be cleaned. In this manner, an operator can systematically move the nozzle and project water within that region R.

The movement of the tipping plate 58 can be affected via a pneumatic or hydraulic cylinder or solenoid 55C. The cylinder 55C can include a ram 55R that attaches to the tipping plate 58. The cylinder 55C can extend and retract the ram 55R therefrom to provide the tilting, tipping or movement of the tipping plate 58 and thus the movement of the water blasting device 40 along the Y axis. Control unit 60 can enable an operator to control this movement and manipulation of the ram or cylinder 55C.

Optionally, in some embodiments, Y axis movement might not be desired. In such a case, the mechanisms and components described above to provide the Y axis movement can be deleted from the construction. Further optionally, Y axis movement may be desired in a different manner, in which case the components above can be modified to include any type of mechanism capable of moving the nozzle 42 in the Y axis. As an example, the holder 56 can be joined with a rack and pinion structure (not shown) that is associated with a connector to move the gun and/or nozzle along the Y axis across a preselected region R. As another example, the holder 56 can be constrained within an elongated slot, and an operator can use manual force to move the holder 56 within the slot, thereby moving the nozzle along the Y axis.

As mentioned above, the water blasting device 40 can be in fluid communication with a water source 80 via one or more hoses or tubes 82. The water source 80 is also in communication and controlled by the control unit 60. The water source can be configured to deliver water under high pressure through the hose 82 to the water blasting device 40, out the nozzle and in particular out orifices 420 defined by the nozzle 42 to project water in a predetermined spray pattern. The water source can be any type of high pressure pump capable of delivering water to the nozzle to a pressure above 1,000 psi, further optionally above 4,000 psi, even further optionally above 10,000 psi, yet further optionally above 20,000 psi, event further optionally above 40,000 psi, and even further optionally up to 100,000 psi. Even under these high pressures, the water blasting device 40 can always be accurately and mechanically controlled and restrained within predetermined areas of movement, with the magnet holding the elongated track and connector in a fixed orientation relative to the equipment to be cleaned, and in particular to the region of cleaning R. Again, with the connector 50, the nozzle 42 is constrained to move within a preselected area relative to the equipment, while the magnets maintain the track 20 in a fixed orientation relative to that equipment and/or other structures surrounding the equipment.

The first and second magnets 31 and 32 used herein can be identical, and are generally illustrated in FIGS. 1 and 6. With reference to FIG. 6, exemplary magnet 31 can include a housing 31H. The housing can include the magnet connecting element 31C projected from it. As mentioned above, this structure can be of a U shape and configured to receive the magnet connecting pin 33 which secures that element within the recess 26R2 defined by the track 20.

The magnet 31 can include an actuator 31L, which is shown as a lever or cam. This actuator can turn the magnet “on” and “off,” increasing and/or decreasing respectively the magnet flux MF generated by an internal magnet 31M disposed in the housing 31H. An exemplary magnet suitable for use with the apparatus 10 is a Mag-Mate Powerlift® magnet available from Industrial Magnetics, Inc., of Boyne City, Mich. The magnet can generally include an interface surface 31I that is adapted to interface with and engage a ferromagnetic surface of a ferromagnetic structure FMS as shown in FIG. 6. The interface surface 31I can be substantially flat and smooth. The magnet 31M can be rare earth magnetic materials or other magnetic materials that selectively applies a magnetic flux MF through the interface surface 31I. Optionally, the magnets can be neodymium magnets, bonded samarium cobalt magnets and/or ceramic magnets. Further optionally, the magnets can exert a magnetic flux MF, and in particular residual inductions, ranging from 2,000 Gauss to 50,000 Gauss, further optionally 10,000 Gauss to 20,000 Gauss. Of course, other magnetic fluxes can be selected, however, the precise amount of magnetic flux is selected to withstand the forces exerted by the water blasting device on the track. As mentioned above, the nozzle projects water at high pressure, creating a jet force which is countered by the magnets holding the track in a fixed orientation and position.

Returning to FIG. 6, the actuator 31L can be associated with one end of the housing 31H and adapted to move one or more potions of the rare earth or other magnetic materials 31M of the magnet 31. The actuator 31L is adapted to selectively configure the magnet in a magnetic mode, in which the magnet exerts the magnetic force MF attracting it to the respective ferromagnetic structure FMS. This magnetic mode is also associated with the engaged positioned of the actuator 31L shown in broken lines in FIG. 6. In this configuration, when in the “on” position, the actuator and magnetic materials 31M of the magnet are configured in such a way with respect to other magnetic materials within the housing 31H that a significant magnetic flux MF is produced through the interface surface 31I, which becomes engaged with a variety of ferromagnetic structures FMS.

The actuator 31L is adapted to selectively configure the magnet in a disengaging mode, in which the magnet is able to be removed under minimal manual force from the ferromagnetic structure FMS. The actuator 31L is moved to the position shown in solid lines to turn the magnet “off” in order to minimize the amount of magnet flux MF emitted through the interface surface 31I. The magnetic flux MF created by the magnet 31, 32 is magnetically engageable with a variety of ferrous metals or materials of the type commonly found in facilities, and around equipment to be cleaned with the water blasting apparatus of the current embodiments.

If desired, the actuator 31L can include one or more stops to physically interfere with the travel of the actuator, in order to lock the magnets in the magnetic mode or the disengaging mode. Optionally, the actuator 31L can be accommodated with a grip of rubber or plastic material to provide a surface with an improved coefficient of friction for grasping by an operator.

Of course in other embodiments, the actuator 31L and the internal magnets 31M can be modified. Another suitable structure for the magnets, which allows removal and engagement of the magnets, is disclosed in U.S. Pat. No. 6,471,273 to Friedrich, which is hereby incorporated by reference in its entirely. Yet other types of magnets, different from that shown in FIG. 6 and explained above, are contemplated. Such magnets can be electromagnets with associated electrical circuits (not shown). With regard to such electromagnets a controller (not shown) such as a switch, rheostat or similar structure can be provided with the electrical circuits to control the magnetic flux of the electromagnets. The switch, rheostat or other controller can provide an operator with the ability to create a magnetic mode where the one or more electromagnetics emits a sufficient magnetic flux, and a disengaging mode where the one or more electromagnets emits substantially no or little magnetic flux—or a magnetic flux that is easily manually overcome by an operator.

As shown in FIG. 6, the water blasting apparatus 10 can include a sensor 80 that is joined optionally with the magnet and/or the track 20. The sensor 80 can be a proximity sensor adapted to detect whether the magnet 31 is sufficiently engaged with a ferromagnetic structure FMS. The proximity sensor can effectively provide a closed electrical circuit that is associated with the control unit 60. When the proximity sensor or the circuit detects that the magnet is becoming disengaged with the ferromagnetic surface FMS, or that the circuit is no longer being completed, the proximity sensor can send a signal either via an electrical hardware connection or via a wireless signal WS to the control unit 60. The control unit 60 can detect this signal, and in immediate response thereto, can automatically shut a valve 80V that is associated with the water source 80, which in turn can stop the flow of high pressure water from the water source 80 to the water blasting device 40. Optionally, the control unit 60 in conjunction with the sensor, can reduce the pressure, flow or volume of water delivered to the water blasting device, in particular the nozzle, when the sensor senses that the magnet is unsatisfactorily engaging the ferromagnetic structure FMS. This in turn can effectively shut down the water blasting device before or precisely when the magnet disengages the ferromagnetic structure. This in turn can prevent the device from violently thrashing around under the propulsion of high pressure water provided via the water source 80.

Operation of the water blasting apparatus and related methods of the current embodiments will now be described. Generally, the method for using the apparatus can include connecting a water blasting device 40 to a track 20, magnetically coupling the track 20 to a ferromagnetic structure FMS so that the nozzle 42 of the device 40 is proximal the equipment 100, 99 to be cleaned. The elongated track is maintained in a fixed orientation via the track and magnetic coupling. Water is shot at high pressure toward the equipment, out the nozzle, while safely restating the water blasting device. Optionally, the device can be constrained to clean along predefined X and Y axes and predefined regions as explained above.

The apparatus can be used in conjunction with cleaning a variety of different structures and equipment such as heat exchangers, falling pressure evaporators, storage tanks, tubes, piping, towers and similar equipment or structures. With reference to FIGS. 1-6, a user can connect magnets 31 and 32 to a track 20. Generally the magnets are in a disengaging mode in this original set up. The track can be positioned adjacent the equipment or structure to be cleaned, for example the heat exchanger 100 or other equipment 99. Optionally, the middle portion 23 can be positioned in a location that enables the connector or tractor to fully access a majority of the equipment and surfaces to be cleaned. To do so, the respective sections 25 and 26 can be telescoped relative to one another and/or the middle portion to increase or decrease the length of the track 20. The operator can attach the magnets to the ends of the track via the pins 33 projecting through the respective connecting elements 31C. When the middle portion 23 is sufficiently placed in front of the equipment or surfaces to be cleaned, the magnetic elements 31 and 32 can be placed adjacent respective first and second ferromagnetic structures FMS. If desired, the magnets can be pivoted relative to the track 20 to sufficiently align the magnets with a ferromagnetic structure FMS before engaging the magnetic flux.

The operator can actuate the actuators of the respective magnets, thereby exerting a magnetic force through the interface 31I and attracting the magnet to the respective ferromagnetic surface. With the magnetic flux in the ranges of Gauss explained above, the magnets are securely magnetically coupled to the ferromagnetic structure FMS. If desired, the operator can rotate or pivot the track 20 at an angle α relative to the magnet as shown in FIG. 6. A user can attach the connector 50 or tractor to the track 20, optionally registering the gear 52 with the respective slots 24 in the track 20. Various other rails and guide wheels (not shown) associated with the connector can be positioned in place relative to the track.

The operator can insert the water blasting device 40 and in particular the barrel 43 through the holder 46. The barrel can be held in place in relation to the holder 56 via a set screw 56S or other connector. The operator can connect the water blasting device 40 via a hose 82 to a water source 80. The user can also connect the cylinder 55C and motor 55 of the tractor to a control unit 60. The water source and associated valve 80V can also be electrically or otherwise coupled to the control unit 60. The control unit 60 further can be placed in communication with sensors 80 via a hard wire or wireless connections. Again, the sensor can detect whether respective magnets 31, 32 are satisfactorily or unsatisfactorily engaging the associated ferromagnetic structures. If at any time during the process the track and/or magnets become decoupled or disengaged from the respective ferromagnetic surfaces, the sensor 80 detects this. It sends a signal to the control unit 60 which, in turn relays a control signal to the dump valve 80V. This in turn trips the dump valve so that the high pressure water is no longer delivered from the source 80 to the hose 82 and thus the water blasting device 40.

By controlling the air motor 55 and the gear 52, the operator can tractor the connector 50 along the track 20 as shown in FIG. 3. This in turn can move the blasting device 40 along an X axis and to clean a desired region R of the equipment. Optionally, the user also can actuate the cylinder 55C to tilt the tipping plate 58 and thus the holder 50 and associated blasting device 40 in direction T. This in turn can move the nozzle to spray or administer high pressure water jet within a region R along a Y axis.

Optionally, where the water blasting device 40 includes a lance and a movable tube, the tube can be inserted into a tube of a heat exchanger or other piping traversing along it, being propelled by the nozzle expelling or shooting water therefrom.

During the cleaning process, water is shot from the nozzle 42 of the blasting device 40 at a pressure above 1,000 psi toward the equipment to clean the equipment. While the water is shot, the water blasting device 40 is safely constrained within an area or region R of movement via connection to the track. The operator can move the water blasting device 40 linearly along the track 20 or X axis while expelling water from the nozzle. The operator also can manipulate the nozzle in the Y axis to shoot water along the Y axis.

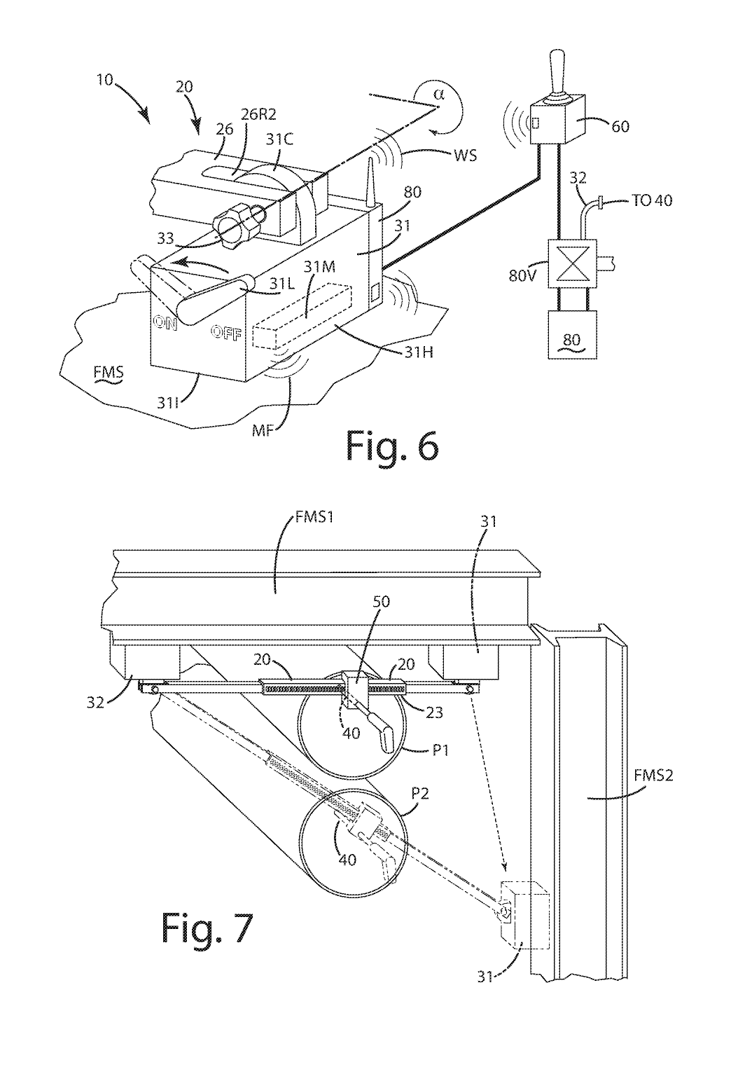

In some cases, multiple pipes or pieces of equipment near one another may be cleaned. This is illustrated in FIG. 7. As shown there, two pipes P1 and P2 are disposed adjacent a first magnetic structure FMS1 and a second magnetic structure FMS2. The first magnetic structure FMS1 can be a ceiling I-beam at the second structure FMS2 can be a vertical sidewall I-beam. To clean the pipe P1, the operator can attach the first and second magnets 31 and 32 to the first magnetic structure FMS1, the ceiling beam. Both can be engaged and the water blasting device 40 can be manipulated to clean the first pipe P1. When the second pipe P2 is to be cleaned, the operator can disengage the magnet 31 from the position shown on the first magnetic structure FMS1, that is the ceiling beam, and move that magnet 31 to the vertical or sidewall ferromagnetic structure FMS2. The user can then reengage the magnet 31 to magnetically couple it to the other ferromagnetic structure FMS2. Optionally, if helpful, the user can telescope the respective sections of the track relative to the middle portion and change the overall length of the track. The user also can move the connector 50 along the middle portion 23 to reorient the water blasting device 40 relative to the pipe P2. A variety of other reorientations of different ends of the track to accommodate differently located equipment to be cleaned are also contemplated.

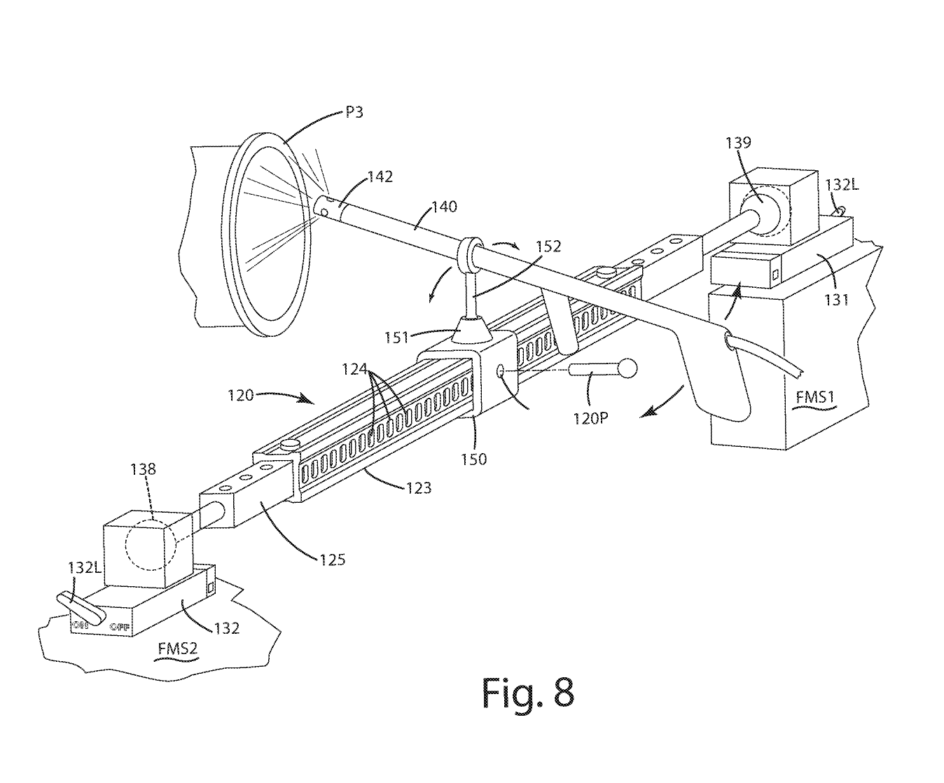

A first alternative embodiment of the water blasting apparatus is illustrated in FIG. 8 and generally designated 110. This apparatus can be used to clean a pipe P3. The apparatus can be similar in structure, function and operation to the embodiment described above with several exceptions. For example, the apparatus 110 can include a track 120. The track 120 includes a first rail 125 and a second rail 123. The second rail 123 can be similar to the middle portion of the embodiments described above. The two rails can be telescopingly joined with one another to alter the overall length of the track 120. Another second section, such as an intermediate section, however, can be absent from this construction. Further, the first section 125 can be joined with a ball and socket joint 138. This ball and socket joint can be directly coupled to the magnet 132, which can be similar to the magnets explained in the embodiments above. The opposing end of the second rail 132 can include another ball and socket joint 139 which is coupled directly to the other magnet 131. Each of the respective magnets can include actuators 131L and 132L as described above in conjunction with the embodiments above. Thus, with these different ball and socket connections between the respective magnets and the track, articulation of the track relative to the magnets can be enhanced. This can also provide extensive swiveling and freedom of movement of the track relative to the pipe and ferromagnetic structures.

In addition, the track can include a connector 150. This connector 150 can include a ball and socket joint 151. The ball and socket joint 151 is further coupled to a linkage 152 which is directly clamped or otherwise joined with the water blasting device 140 which as illustrated is in the form of a high pressure water blasting gun. This gun includes a nozzle 142 that can expel water from the gun.

The track 120, and in particular the second rail 123, also can define multiple holes 124. The connector 150 can define a hole 150H through which a pin 120P is placed to register the connector 150 in a fixed orientation relative to the respective holes 124 defined by the track 120. This in turn can precisely position the connector and thus the water blasting device relative to the pipe P3. In this configuration it is noted that the linkage 152 can provide an extended amount of articulation, movement and relative rotation of the nozzle 142 and the gun 140. With this linkage 152, the movement of the gun and its nozzle are restrained within a predetermined area.

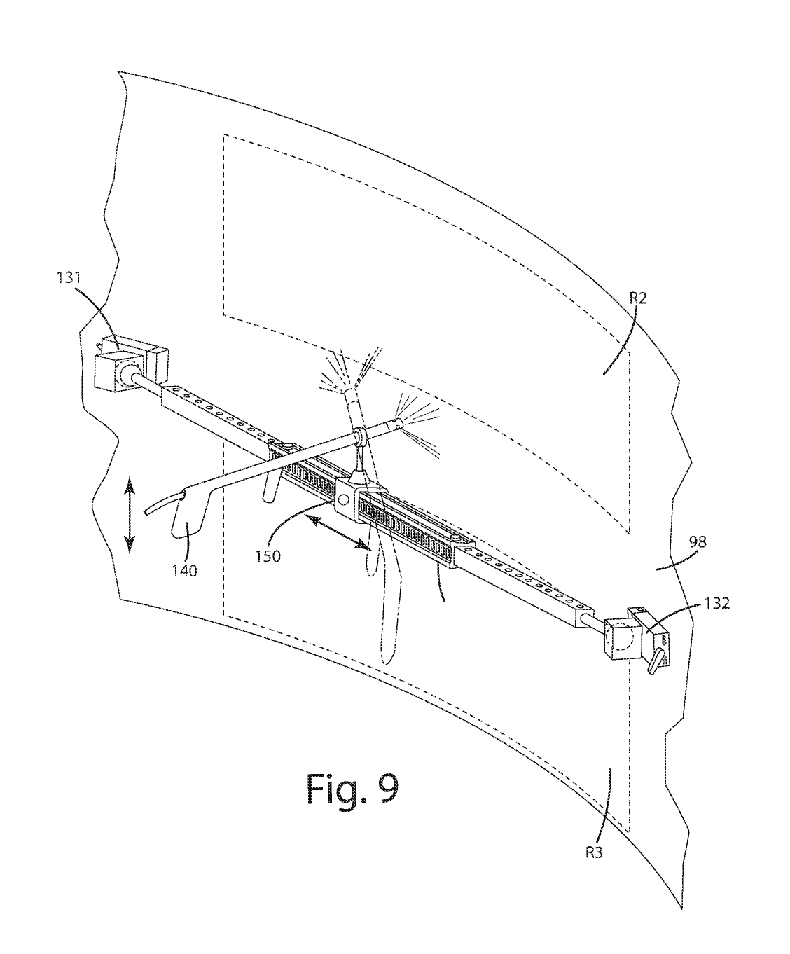

Another application of this embodiment is illustrated in FIG. 9. There, the track 120 is attached via the magnets 131 and 132 to the inside of a tank 98. The tank can be, for example, a large crude oil storage tank with excessive sludge build-up on its walls The water blasting device 140 can be joined with the connector 150 on the track 120 and selectively moved along it. The blasting device 140 can be swiveled and moved relative to the connector 150 and the track 120 to clean a region R2 while the device is connected to the wall in the orientation as illustrated. When this region R2 is cleaned, the magnets 131 and 132 can be disconnected and magnetically coupled to other locations to clean another region R3 in a similar manner.

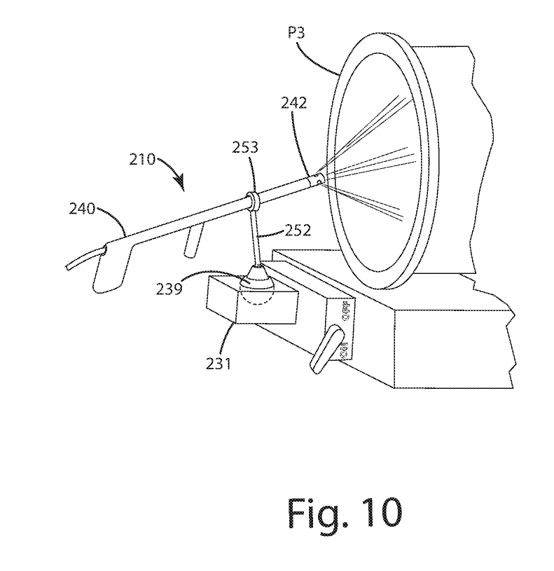

A second alternative embodiment of the water blasting apparatus is illustrated in FIG. 10 and generally designated 210. This apparatus is similar in structure, function and operation of the embodiments above with several exceptions. For example, the apparatus 210 includes a water blasting device 240 having a nozzle 242. The nozzle can be placed within the pipe P3. A single magnet 231 can include a ball and socket joint 239. To this ball and socket joint a linkage 252 can be connected and extend upwardly to a clamp or holder 253 which attaches directly to the barrel of the water blasting device 240. In this construction the track is eliminated and the link basically takes its place to restrain the movement of the water blasting device in a preselected region within the pipe P3. The magnet 231 can be operated similar to the embodiments above. In this embodiment, however, the user manually manipulates the water blasting device 240, moving it around relative to the interior of the pipe P3 or other equipment to be cleaned.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of cleaning equipment, the method comprising:
providing a water blasting device including a nozzle defining an orifice joined with a water source configured to deliver water to the nozzle at a pressure above 1000 psi;
providing an elongated track including a first end and a second end, with a middle portion therebetween, the first end joined with a first magnet, the second end joined with a second magnet;
magnetically coupling the first magnet to a first ferromagnetic structure and the second magnet to a second ferromagnetic structure distal from the first ferromagnetic structure, so that the elongated track is in a fixed orientation relative to and adjacent an equipment; and
joining the water blasting device with a connector to the elongated track so that the nozzle is proximal the equipment, and so that the nozzle is constrained to move within a preselected area relative to the equipment, while the first magnet and second magnet maintain the elongated track in a the fixed orientation.

2. The method of claim 1 wherein the first end is formed by a first section, the first section being telescopingly joined with the middle portion, comprising extending the first section so that the first end moves away from the middle portion.

3. The method of claim 2 wherein the middle portion includes a drive track, wherein the connector includes a gear, comprising engaging the gear with the drive track to move the connector along the elongated track.

4. The method of claim 1 wherein the first magnet includes an actuator, comprising actuating the actuator so that the first magnet decouples from the first magnetic structure.

5. The method of claim 4 comprising removing the first magnet from the first ferromagnetic structure and magnetically coupling the first magnet to a third ferromagnetic structure distal from the first ferromagnetic structure.

6. The method of claim 1 comprising expelling water from the nozzle at a pressure above 1000 psi toward the target equipment to remove contaminants from the target equipment, and automatically ceasing the expelling of water from the nozzle upon decoupling of the track from the first ferromagnetic structure.

7. The method of claim 1 comprising pivoting the first magnet about a pivot axis associated with the first end to align the first magnet with a first surface of the first ferromagnetic structure.

8. A method of cleaning equipment, the method comprising:
connecting a water blasting device to a track, the water blasting device including a nozzle defining an orifice joined with a water source configured to deliver water to the nozzle;
magnetically coupling the track to at least one ferromagnetic structure so that the nozzle is proximal an equipment, and so that the elongated track is maintained in a fixed orientation relative to the equipment; and
shooting water from the nozzle at a pressure above 1000 psi toward the equipment to clean the equipment,
whereby the water blasting device is safely restrained within an area of movement via connection to the track.

9. The method of claim 8 wherein the track includes a first magnet and a second magnet, each including an actuator configured to put the respective magnet into a magnetic mode or a disengaged mode, comprising placing the first magnet adjacent the ferromagnetic structure and moving the actuator to put the first magnet into the magnetic mode whereby the first magnet magnetically couples to the ferromagnetic structure.

10. The method of claim 8 comprising moving the water blasting device linearly along the track from a first location to a second location.

11. The method of claim 8 wherein the equipment is a heat exchanger including a plurality of tubes, comprising placing the nozzle immediately adjacent one of the plurality of tubes, and advancing the nozzle into the one of the plurality of tubes so that the water shot from the nozzle cleans the tube.

12. The method of claim 11 wherein the heat exchanger includes a face plate disposed perpendicular to the plurality of tubes, wherein the magnetically coupling step includes placing a rare earth magnet adjacent the face plate and wherein the face plate forms the ferromagnetic structure.

13. The method of claim 8 wherein the track includes first and second sections, comprising telescoping the first section relative to the second section to increase a length of the track.

14. The method of claim 8 wherein the track includes a first end and a second end, wherein the first end includes a first magnet, comprising pivoting the first magnet relative to the first end to align the first magnet with the ferromagnetic structure.

15. The method of claim 8 comprising tilting the water blasting device about a fulcrum during said shooting step.

16. The method of claim 8 comprising automatically ceasing the shooting of water from the nozzle upon decoupling of the track from the at least one ferromagnetic structure.

17. A water blasting apparatus adapted to clean residue from a surface comprising:
an elongated track including a first end and a second end telescopingly joined with a middle portion located therebetween;
a connector movably joined with the elongated track and adapted to traverse the middle portion in a linear manner;
a water blasting device including a nozzle defining an orifice joined with a water source configured to deliver water to the nozzle at a pressure above 1000 psi, the water blasting device joined with the connector so that at least one of the nozzle and the water blasting device are constrained to shoot water at a preselected area;
a control unit in communication with the water source;
a first rare earth magnet, including a first actuator adapted to selectively configure the magnet in either a magnetic mode, in which the magnet magnetically attracts to a first ferromagnetic structure, and a disengaging mode, in which the magnet is able to be disengaged from the first ferromagnetic structure, the first rare earth magnet pivotally joined with the first end of the track;
a second rare earth magnet, including a second actuator adapted to selectively configure the magnet in either a magnetic mode, in which the magnet magnetically attracts to a second ferromagnetic structure, and a disengaging mode, in which the magnet is able to be removed from the second ferromagnetic structure, the second rare earth magnet pivotally joined with the second end of the track; and
a sensor joined with at least one of the first rare magnet and the second rare earth magnet, the sensor in communication with the control unit, the sensor adapted to sense whether or not the at least one of the first rare magnet and the second rare earth magnet are sufficiently engaging the respective first ferromagnetic structure and the second ferromagnetic structure,
wherein the control unit is adapted to reduce the water delivered to the nozzle when the sensor senses that the at least one of the first rare magnet and the second rare earth magnet are unsatisfactorily engaging the respective first ferromagnetic structure and the second ferromagnetic structure.

18. The water blasting apparatus of claim 17 wherein the connector includes a housing and a gear within the housing, the gear being registered with a feature of the elongated track, wherein the gear is rotatable to move the housing along the track.

19. The water blasting apparatus of claim 17 wherein the sensor is a proximity sensor joined the first rare earth magnet, the proximity sensor being in communication with the control unit, wherein the proximity sensor generates a signal indicative of the first rare earth magnet unsatisfactorily engaging the respective first ferromagnetic structure.

20. A water blasting apparatus adapted to clean surfaces of a target equipment, the apparatus comprising:
an elongated track including a first portion and a second portion telescopingly joined with one another;
a connector joined with and moveable along the elongated track;
a water blasting device including a nozzle defining an orifice joined with a water source configured to deliver water to the nozzle at a pressure above 1000 psi, the water blasting device joined with the connector; and
a rare earth magnet joined with the elongated track and adapted to join the track with a ferromagnetic structure, thereby holding the track in a fixed orientation relative to a target equipment,
whereby the connector and track cooperatively restrain movement of the water blasting device to prevent the device from violently thrashing around.
